(19) United States
(12) Patent Application Publication
(10) Pub. No.: US 2019/0259256 A1
(43) Pub. Date: Aug. 22, 2019

(54) WORK ZONE INTRUSION ALERT SYSTEM

(71) Applicant: FirstEnergy Corp., Akron, OH (US)

(72) Inventor: William Fairweather, Wooster, OH (US)

(73) Assignee: FirstEnergy Corp., Akron, OH (US)

(21) Appl. No.: 16/278,990

(22) Filed: Feb. 19, 2019

Related U.S. Application Data
(60) Provisional application No. 62/631,525, filed on Feb. 16, 2018.

(51) Int. Cl. G08B 13/12

(52) U.S. Cl. CPC G08B 13/122

(57) ABSTRACT

One or more techniques and/or systems are disclosed for warning workers in a work zone of a potential intrusion by a vehicle. The example system can comprise a master device, coupled with one or more boundary markers using a tripwire. When the trip wire, and/or one of the boundary markers, is impacted with sufficient force, the tripwire is disengaged from the master device. Once disengaged, the master device can transmit a wireless alert signal to one or more portable alerter, such as worn by workers. The portable alerters can receive the signal and activate a personnel alert, such as an audible, visual, or other sensory alert. In this way, an alert is provided to personnel working in an established work zone that a potentially threatening vehicle has penetrated the work zone perimeter. This type of alert may provide the personnel the vital seconds needed to move to safety.

### CROSS-REFERENCE TO RELATED APPLICATIONS

This application claims priority to U.S. Ser. No. 62/631,525, entitled WORK ZONE INTRUSION ALERT SYSTEM, filed Feb. 16, 2018, which is incorporated in its entirety herein.

### BACKGROUND

Work zone safety may be important for personnel working in areas subject to vehicle traffic, such as on roadways, industrial throughways, and other areas. Some systems can alert workers when an unauthorized vehicle enters the work zone. Existing devices may utilize some of the following methods to provide an alert to a worker; 1) a compressed CO₂ canister, 2) wireless network communication, and 3) air compression hoses linked to portable vibration alert devices that are worn by the workers.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized to provide an alert to one or more workers in a work zone of a potential intrusion by a vehicle. For example, by providing an alert, such as an audible, visible, or sensory warning, in one or more locations, the work zone intrusion alert system, described herein, can alert personnel working in an established work zone that an unauthorized vehicle has penetrated the work zone perimeter. This type of alert may provide the personnel time to move out of the way of the vehicle. For example, the system can be deployed in frequently moving, or temporary work zones, where safety barriers may not be a viable option, such as where a vehicle lane closure is undertaken.

In one implementation of a system for alerting personnel proximate a work zone to a work zone intrusion, a master device can be configured to operably engage with a first boundary marker. The master device can activate an alert state resulting in the master device wirelessly transmitting an alert signal to one or more portable alert devices. Further, the example system can comprise a tripwire that comprising a coupler. The coupler can selectably, operably engage with the master device; and the coupler can disengage from the master device upon receiving a pre-determined amount of pulling force equivalent to an impact force on the tripwire. Additionally, the example system can comprise a first boundary marker engaging component that is operably, fixedly engaged with the tripwire at a first distance from the coupler. The first boundary marker engaging component can be operably, selectably engaged with a second boundary marker. In this system, the disengaging of the coupler from the master device can result in the master device activating the alert state. The one or more portable alerters can respectively receive the alert signal from the master device and provide an alert to proximate personnel.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIGS. 1A and 1B are component diagrams of one implementation of an exemplary system 100 for providing a work zone intrusion alert.

FIGS. 2A and 2B are component diagrams illustrating schematic implementations of example components of one or more systems described herein.

FIGS. 3A, 3B, and 3C illustrate an example implementation of one or more portions of one or more systems described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In one aspect, a temporary work environment, such as one that is frequently on the move (e.g., on a roadway), does not typically permit the use of barriers to mitigate intrusion by vehicles (e.g., concrete barriers) to protect workers from vehicles that may breach a work zone's perimeter. Often, the workers utilize a set of one or more temporary boundary markers (e.g., cones, barrels, etc.), or the like, to demarcate the work zone, which merely provide a visual indication of a barrier, and provide little protection from intruding vehicles, for example. A system may be devised for providing a work zone intrusion alert, which could increase a worker's safety in these types of situations, while also being convenient and easy to use. As an example, when a vehicle crosses the traffic boundary marker perimeter, the system can activate an intrusion alert that provides an alert (e.g., audible, visual, sensory) at one or more appropriate locations. In this example, this type of advanced warning may give the workers the added time to take action to avoid the intruding vehicle.

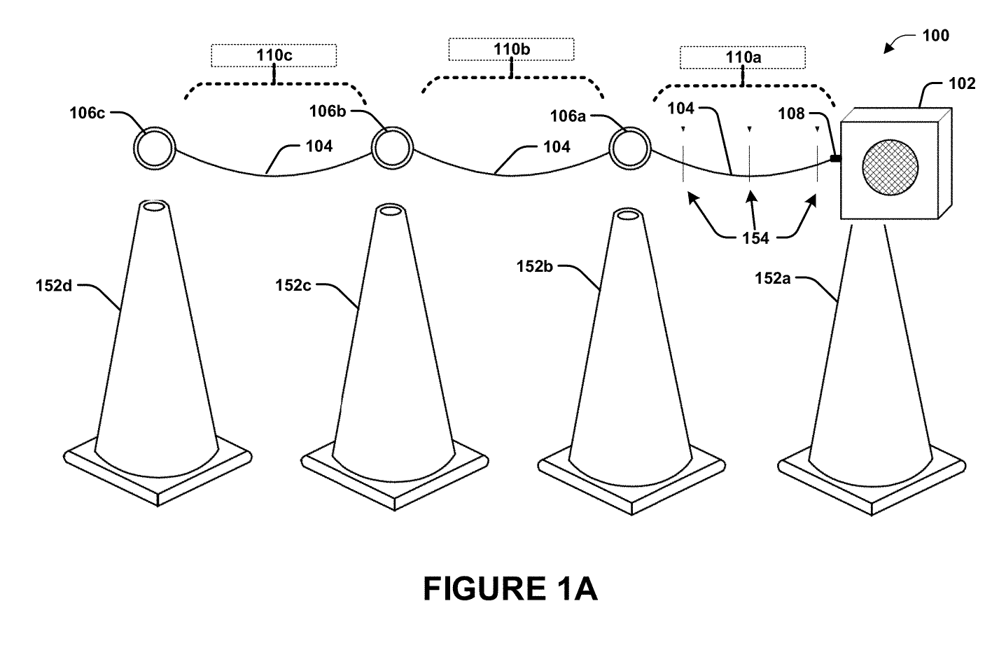

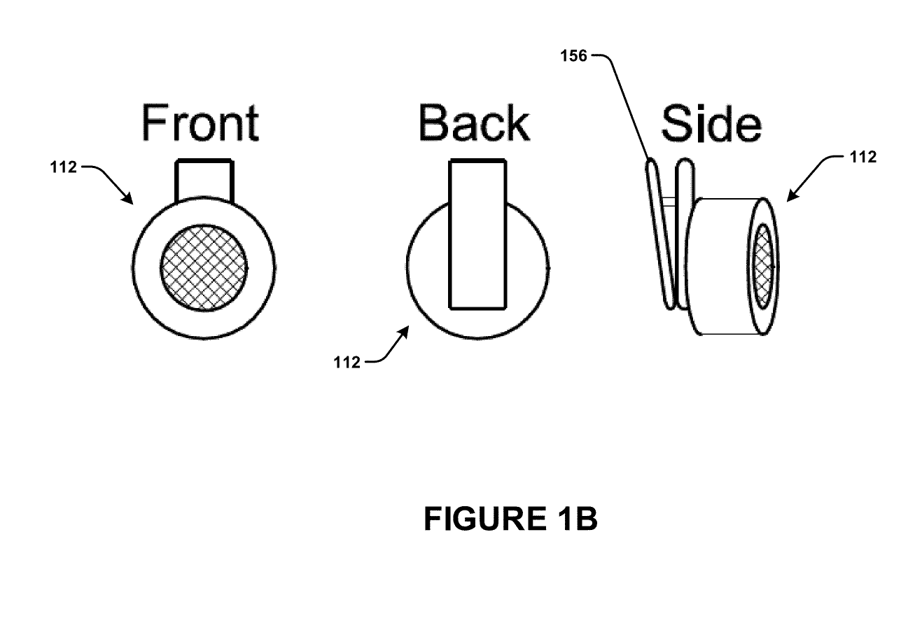

FIGS. 1A and 1B are component diagrams of one implementation of an exemplary system 100 for providing a work zone intrusion alert. In this implementation, the exemplary system 100 can comprise a master device 102. The master device can comprise a housing to house components of the master device 102, internally (e.g., protection from environment, impact, etc.). The master device 102 housing can be configured to be mounted on a traffic boundary marker 152, for example, such as one that is disposed farthest from the work zone, and closest to potentially intruding vehicles. As an example, the master device 102 housing can comprise a feature (e.g., cavity or indentation) that allows it to be engaged with a work zone boundary marker, such as a cone, barrel, upright, post, pole, etc. As another example, the master device can comprise an engaging component, such as a clip, projection, clasp, or some type of fastening device that allows it to be selectably engaged with a work zone boundary marker.

As illustrated in FIG. 1A, the exemplary system 100 can comprise a tripwire 104 (e.g., cable, wire, rope, chain, etc.). In one implementation, the tripwire 104 can be strung from boundary marker to boundary marker, where the tripwire 104 can serve as a sort of detection barrier to cover the spaces between respective work zone boundary markers 152. In one implementation, the tripwire 104 may comprise a coupler 108 that is configured to operably, selectably engage with the master device 102. That is, for example, the coupler 108 is disposed at a coupler end of the tripwire 104, and selectably engages with the master device 102 during operation of a work zone intrusion alert system.

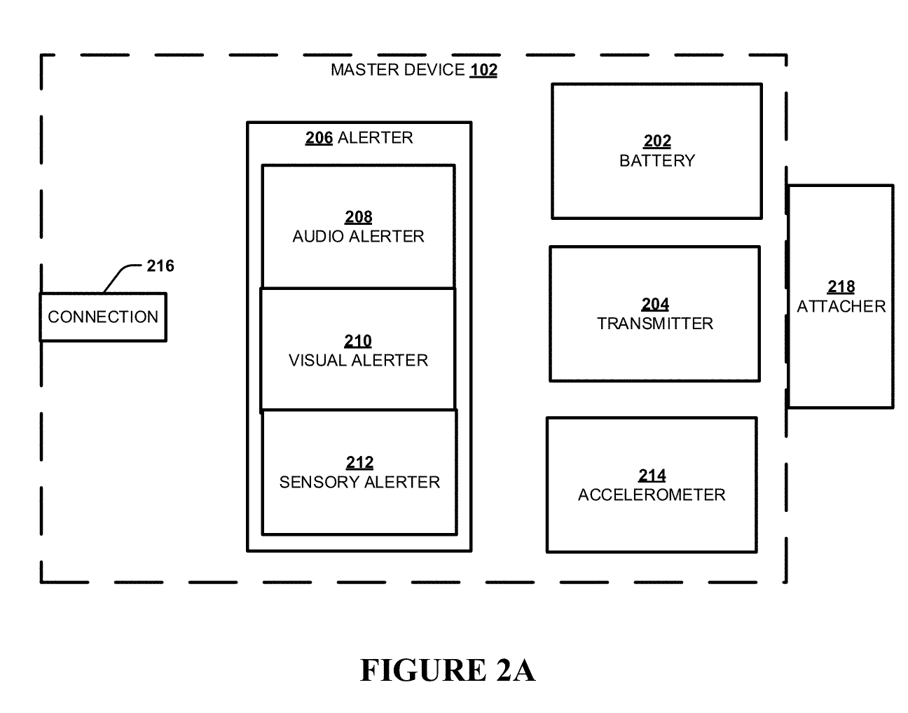

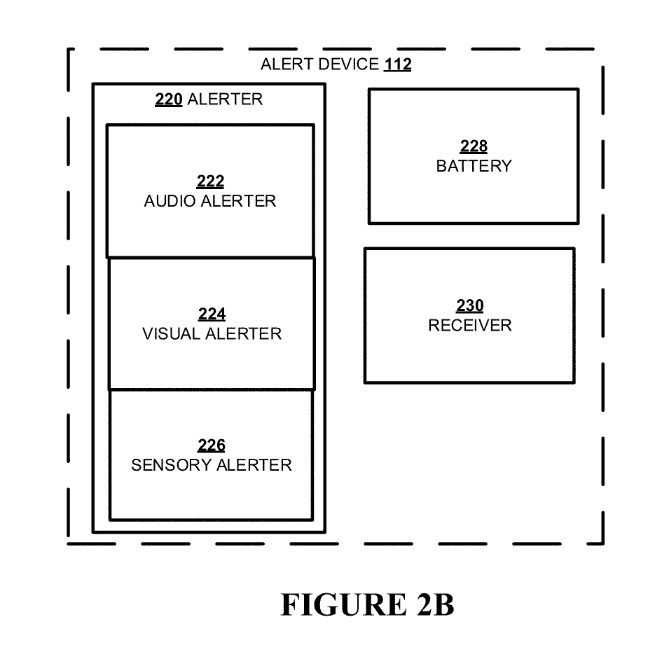

As an example, the coupler 108 can engage with master device 102 by coupling with a connection (216, FIG. 2A) in the master device 102. An example of the coupler engaging the master device can comprise inserting the coupler 108 in the connection 216, magnetically coupling the coupler 108 with the connection 216, otherwise coupling the coupler 108 with the connection 216 such that the coupler 108 stays in place during normal operation of the system, but disengages from the master device 102 (e.g., from the connection 216) under a pre-determined load applied to the coupler 108. For example, a pre-determined force applied to the tripwire 104 can apply that force to the coupler 108, which can disengage the coupler from the master device 102.

In one implementation, the master device 102 can be configured to detect when the coupler 108 is disengaged from the connection 216. For example, when operably engaged, the coupler 108 may hold a switch in an open position, and when the coupler is disengaged the switch may default to a closed position, which can provide for detection of the coupler 108 disengaging from the connection 216. As another example, breaking of a magnetic coupling may activate a signal that indicates the coupler 108 disengaging from the connection 216. It should be appreciated that it is anticipated that there are several ways to detect decoupling of one component from another.

As an illustrative example, the tripwire 104 is operably, selectably engaged with the master device 102 using the coupler 108. In this example, when the tripwire 104 is impacted and pulled by a vehicle that crosses the work zone boundary, the coupler 108 can be disengaged from the master device 102, which can result in an activation the system to provide an alert.

Further, as shown in FIG. 1A, the exemplary system 100 can comprise one or more boundary marker engaging components 106, such as a first boundary marker engaging component 106a, a second boundary marker engaging component 106b, a third boundary marker engaging component 106c (e.g., and so-on). In one implementation, the respective boundary marker engaging components 106 can be configured to operably, selectably engage with a work zone boundary marker 152. That is, for example, the first boundary marker engaging component 106a can selectably engage with a second work zone boundary marker 152b; the second boundary marker engaging component 106b can selectably engage with a third work zone boundary marker 152c; the third boundary marker engaging component 106c can selectably engage with a fourth work zone boundary marker 152d (e.g., and so-on). It should be appreciated that the work zone intrusion system may merely comprise the first boundary marker engaging component 106a that engages with the second work zone boundary marker 152b; or may comprise the first and the second boundary marker engaging component 106b engaging with the third work zone boundary marker 152c (e.g., or the third, fourth, etc.). That is, the example, system can be scalable to comprise a desired number of boundary markers, selected for an expected work zone boundary size, shape, and or desired distance between boundary markers.

As one example, the boundary marker engaging components 106 may comprise cone mountable rings, that are selectably engagable in an operably, fixed engagement (e.g., or integrated) with the tripwire 104, and attach (e.g., slide on) to the respective boundary markers 152. In this way, for example, the boundary marker engaging components 106 can be used to engage the tripwire 104 with the respective boundary markers 152. For example, the tripwire 104 can comprise segments that are attached to a boundary marker engaging components 106, in a chain, with respective boundary marker engaging components 106 selectably engaged with a boundary marker 152, to form a physically demarcated boundary to the work zone. Additionally, as illustrated in FIG. 1A, and described above, at least one of the segments of the tripwire 104 can be selectably, operably coupled with the master device 102 using the coupler 108. In that way, for example, when one of the boundary markers 152 are displaced (e.g., or the tripwire 104 is displaced), such as by an impact, the tripwire 104 can be disengaged from the master device 102 to activate the alert system.

In one implementation, as illustrated in FIG. 1A, the exemplary system may comprise one or more measuring increments 154, disposed on the tripwire 104 (e.g., marked by color or other marking on the tripwire). In one implementation, the measuring increments 154 may assist a worker during a set-up process, by helping them identify an appropriate distance between boundary markers 152, for example, determined by the roadway's posted speed limit. For example, the distance may be specified by some regulatory agency, policy or other appropriate engineering factors (e.g., by the Occupational Safety and Health Administration (OSHA)).

In one implementation, the respective sections of the tripwire 104 can comprise a pre-determined, specified distance, for example, appropriate for a particular use. That is, for example, a first distance 110a can comprise the distance from the coupler 108 to the first boundary marker engaging component 106a on the tripwire. Further, a second distance 110b can comprise the distance between the first boundary marker engaging component 106a and the second boundary marker engaging component 106b on the tripwire 104 (e.g., and so-on for a third distance 110c, etc.).

As illustrated in FIG. 1B, the exemplary system 100 of can comprise one or more portable alerters 112 (e.g., portable alarm). In one implementation, the device may be small enough to be effectively worn on, and/or used by, personnel in the work zone, such as on a belt or clothing of a worker. In one implementation, the portable alerter 112 can comprise an engagement component 156, such as a clip or other temporary engaging component, or can be placed in a convenient location in the work zone. As an example, when the portable alerter 112 receives a wireless alert signal from the master device 102, it can activate an alert (e.g., audible, visual, sensory), such as using an audible speaker 15 (e.g., or strobe, vibration, or other alert), for example, to alert proximate personnel of a potential work zone intrusion.

With continued reference to FIGS. 1A and 1B, FIGS. 2A and 2B are component diagrams illustrating schematic implementations of example components of one or more systems described herein. As illustrated in FIG. 2A, the master device 102 can comprise a battery 202 that provides electrical power to the master device 102, and one or more of the various components therein. Further, the master device 102 can comprise a wireless transmitter 204 that transmits a wireless alert signal when an alert state is activated in the system. Additionally, the master device 102 can comprise an alerting component 206 that provides an alert to proximate personnel. In one implementation, the alerting component 206 can comprise one or more of: an audio alerter 208, such as an audible speaker (e.g., emitting an alarm sound); a visual alerter 210, such as a set of one or more lights (e.g., flashing strobe, etc.); and a sensory alerter 212, such as a vibrating device that produces a vibration detectable by personnel proximate the master device 102.

In one implementation, the master device 102 can comprise an accelerometer 214 that can detect movement of the master device 102. For example, if the accelerometer 214 detects that the master device 102 has moved past a threshold acceleration (e.g., or tilt), such as when impacted with sufficient force, the alert system can be activated. As an example, the work zone boundary marker 152a (e.g., cone, barrel, etc.) with which the master device 102 is engaged may be struck directly, or at any angle, by a vehicle, and the tripwire 104, described above, may not disconnect from the master device 102. In this example, the accelerometer 214 can detect the sudden acceleration caused by the impact, resulting in activation of the alert system (e.g., alert state). In one implementation, the master device 102 can comprise an attachment component 218 that is used to operably, selectably engage the master device 102 (e.g., the housing of the master device 102) with the work zone boundary marker 152a.

FIG. 2B illustrates one implementation of an example portable alert device 112, which can be worn by personnel and/or placed in or proximate to the work zone within alerting distance from the personnel. In this implementation, the portable alert device 112 can comprise a battery 228 that provides electrical power to the portable alert device 112, and one or more of the various components therein. Further, the portable alert device 112 can comprise a wireless receiver 204 that receives the wireless alert signal transmitted by the master device 102. Additionally, the portable alert device 112 can comprise an alerting component 220 that provides an alert to proximate personnel to the portable alert device 112. In one implementation, the alerting component 220 can comprise one or more of: a portable audio alerter 222, such as an audible speaker (e.g., emitting an alarm sound); a portable visual alerter 224, such as a set of one or more lights (e.g., flashing strobe, etc.); and a portable sensory alerter 226, such as a vibrating device that produces a vibration detectable by personnel proximate the portable alert device 112.

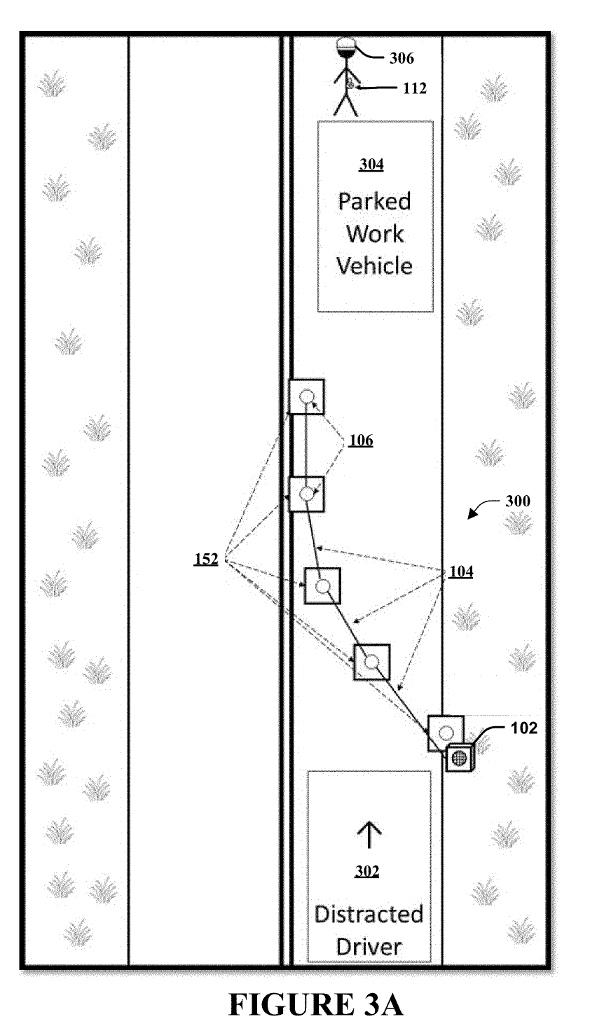

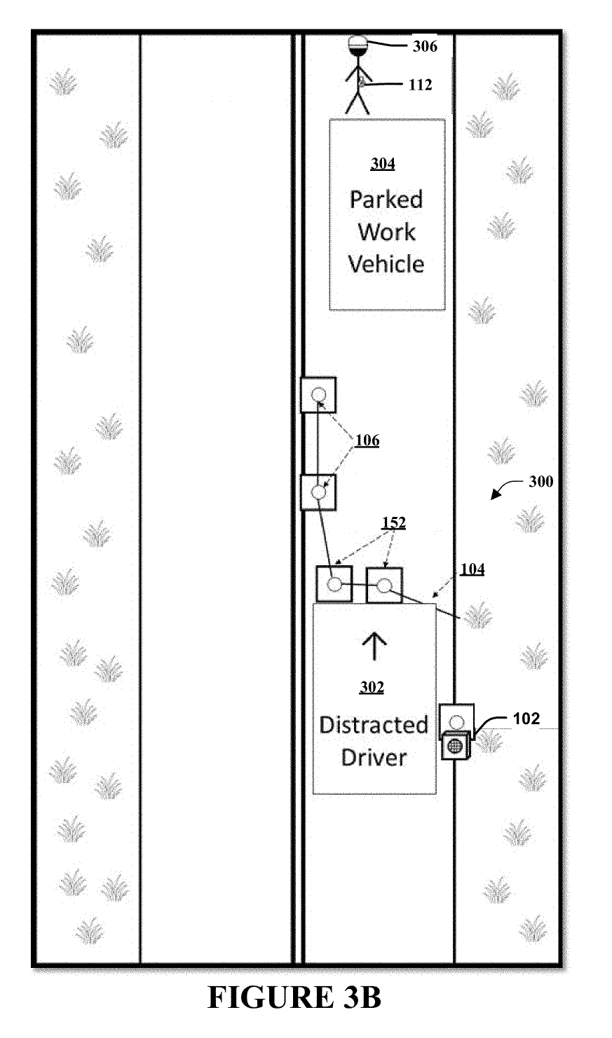

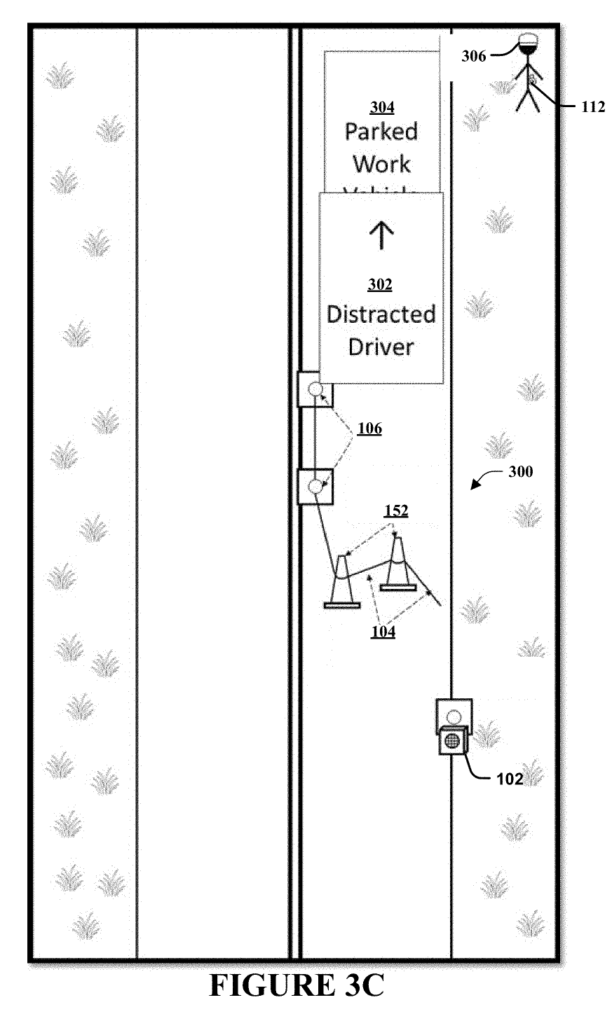

With continued reference to FIGS. 1A, 1B, 2A, and 2B, FIGS. 3A, 3B, and 3C, illustrate an example implementation of one or more portions of one or more systems described herein. As an illustrative example, FIGS. 3A-3C depict a top down view of an example work zone on a single lane road, comprising two sides. Of note, the work zone is not to scale, and a variety of factors, including the speed limit of a road, weather and other factors, can be determinative of the appropriate placement of the work zone boundary markers 152 behind a work vehicle 304. In the illustrative implementation of FIG. 3A, a worker 306, wearing the portable alerter 112, is positioned in front of a parked work vehicle 304, with an example work zone intrusion alarm system 300, as described herein, set up behind the parked work vehicle 304. The example work zone intrusion alarm system 300 comprises the master device 102, operably engaged with the tripwire 104 (using the coupler, not shown). Respective boundary marker engaging components 106 are each selectably engaged with a corresponding work zone boundary marker 152. Further, a distracted driver 302 is approaching the demarcated work zone from the bottom.

In the illustrative implementation of FIG. 3B, the distracted driver 302 has made contact with/impacted the tripwire 104 that is engaged with the work zone boundary markers 152, and held in place by the boundary marker engaging components 106. Further, the tripwire 104 has been disconnected (at the coupler, not shown) from the master device 102, whereupon the master device 102 detects the decoupling of the coupler from the master device 102, and activates an alert state. Activation of the alert state can result in the alerting component (e.g., 206 of FIG. 2A) providing an alert to the worker 306, such as an audible siren (e.g., and/or flashing strobe, etc.). At substantially the same time, the wireless transmitter (e.g., 204 of FIG. 2A) in master device 102 can transmit the alert signal. Those portable alert devices 112 that are within range of the transmission can receive the alert signal, using the portable alerters receiver (e.g., 230 of FIG. 2B). Upon receiving the alert signal the portable alerter 112 can activate the portable alerter 220, such as an audible speaker 222 (e.g., or other alert component 224, 226), which can emit an audible alert (e.g. siren) like noise. In this way, for example, when both the master device's 102 alerting component 206 and portable alerters alerting component 220 produce an alert that is detectable by the worker 306, they may be appropriately alerted that the work zone perimeter has been breached, possibly by a distracted driver 302.

In the illustrative implementation of FIG. 1A, the result of a successful operation of the work zone intrusion alerting system 300 can provide the worker 306 additional time, than without the alert, to move out of a potential oncoming vehicle (e.g., to safety) in response to the alert. As an example, the distracted driver 302 may collide with the back of the parked work vehicle 304. However, in this example, because the worker 306 was alerted prior to the potential collision, they had additional time to move off the road prior to the impact occurring.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof

What is claimed is:

1. A system for alerting personnel proximate a work zone to a work zone intrusion, comprising:
a master device that operably engages with a first boundary marker to activate an alert state resulting in the master device wirelessly transmitting an alert signal to one or more portable alert devices;
a tripwire comprising a coupler that selectably, operably engages with the master device, the coupler disengaging from the master device upon receiving a pre-determined amount of pulling force equivalent to an impact force on the tripwire; and
a first boundary marker engaging component operably, fixedly engaged with the tripwire at a first distance from the coupler, the first boundary marker engaging component operably, selectably engaging with a second boundary marker;
wherein the disengaging of the coupler from the master device results in the master device activating the alert state; and
wherein the one or more portable alerters respectively receive the alert signal from the master device and provide an alert to proximate personnel.

2. The system of claim 1, comprising a second boundary marker engaging component operably, fixedly engaged with the tripwire at a second distance from the coupler that is greater than the first distance, the second boundary marker engaging component operably, selectably engaging with a third boundary marker.

3. The system of claim 1, the master device comprising:
a master battery to provide electrical power;
a master audio alert device to provide an audio alert upon activation of the alert state; and
a transmitter to transmit the alert signal.

4. The system of claim 3, the master device comprising an accelerometer to detect movement of the master device.

5. The system of claim 4, the master device transmitting activating the alert state when the accelerometer detects movement above a movement threshold.

6. The system of claim 4, the master device comprising one or more of a master visual alert device to provide a visual alert upon activation of the alert state, and a master sensory alert device to provide a sensory alert upon activation of the alert state.

7. The system of claim 1, the one or more portable alerters respectively comprising:
a portable alerter battery to provide electrical power;
a portable alerter audio alert device to provide an audio alert; and
a receiver to receive the alert signal.

8. The system of claim 7, the one or more portable alerters respectively comprising one or more of a portable alerter visual alert device to provide a visual alert, and a portable alerter sensory alert device to provide a sensory alert.

9. The system of claim 1, the tripwire comprising distance measurement markings disposed along at least a portion of the tripwire.

10. The system of claim 1, the first boundary marker engaging component configured to be selectably disengaged from the tripwire, and re-engaged with the tripwire at a different distance than the first distance.

11. The system of claim 1, the pre-determined amount of pulling force sufficient to disengage the coupler from the master device when the tripwire is impacted by a vehicle moving into a work zone demarcated by at least the first and second first boundary marker with the tripwire disposed between.

12. The system of claim 1, one or more portable alert devices one or more portable alert devices comprising a mobile computing device comprising an application disposed thereon that activates the mobile computing device to provide the alert to proximate personnel upon the mobile computing device receiving the alert signal.

13. A work zone intrusion alert system, comprising:
a first boundary marker and a second boundary marker, respectively to stand alone and apart from each other to demarcate at least a portion of a boundary of a work zone;
a tripwire comprising a coupler;
a master device operably, selectably engaged with the first boundary marker, the master device operably, selectably coupled with the coupler, the master device disengaging from the coupler under a pre-determined load applied to the coupler resulting in the master device activating an alert state resulting in the master device wirelessly transmitting an alert signal;
a first boundary marker connector operably, fixedly engaged with the tripwire at a first distance from the coupler, the first boundary marker connector operably, selectably engaged with the second boundary marker;
a first portable alerter that wirelessly receives the alert signal and produces an alert detectable by personnel proximate the work zone.

14. The system of claim 13, comprising a third boundary marker, and a second boundary marker connector operably, fixedly engaged with the tripwire at a second distance from the coupler, the second boundary marker connector operably, selectably engaged with the third boundary marker.

15. The system of claim 13, the alert detectable by personnel proximate the work zone comprising one or more of:
an audible alert detectable remotely from the first portable alerter;
a visual alert detectable remotely from the first portable alerter; and
a sensory alert detectable when personnel are in contact with the first portable alerter.

16. The system of claim 13, the master device comprising:
a battery to provide electrical power to the master device;
a transmitter to transmit the alert signal; and
one or more of:
a speaker to provide an audible alert;
a set of one or more lights to provide a visual alert; and
an accelerometer to detect movement of the master device over a movement threshold resulting in the master device activating the alert state.

17. The system of claim 13, the first portable alerter comprising a portable computing device comprising an application disposed thereon that activates the portable computing device to produce the alert detectable by personnel proximate the work zone upon the portable computing device receiving the alert signal.

18. The system of claim 13, the predetermined load applied to the coupler equivalent to a force sufficient to disengage the coupler from the master device when a vehicle impacts the tripwire or any of the boundary markers engaged with a corresponding boundary marker connector.

19. A method for alerting personnel proximate a work zone to a work zone intrusion, comprising:
setting up at least a first work zone boundary marker and a second work zone boundary marker to demarcate the boundary of a work zone;
selectably engaging a master device with the first work zone boundary marker;
selectably engaging first boundary marker engaging component with the second work zone boundary marker, first boundary marker engaging component operably, fixedly engaged with a tripwire at a first distance from a coupler end of the tripwire;
engaging a coupler, disposed at the coupler end of tripwire, with the master device, thereby stringing the tripwire between the first work zone boundary marker and the second work zone boundary marker, wherein the master device activates an alert state when the coupler is disengaged from the master device resulting in the master device transmitting an alert signal;
disposing one or more portable alerters proximate personnel in the work zone, the portable alerters receiving the alert signal and providing an alert to the proximate personnel.

20. The method of claim 19, the coupler disengaging from the master device under a pre-determined load applied to the coupler.
